(19) United States
(12) Patent Application Publication
(10) Pub. No.: US 2011/0004845 A1
(43) Pub. Date: Jan. 6, 2011

(54) Method and System For Notifying A User of An Event Or Information Using Motion And Transparency On A Small Screen Display

(75) Inventor: Mario Ciabarra, Colorado Springs, CO (US)

Correspondence Address: Intelliborn Corporation, 15823 Woodmeadow Ct, Colorado Springs, CO, 80921, US

(73) Assignee: INTELLIBORN CORPORATION, Colorado Springs, CO (US)

(21) Appl. No.: 12/774,735

(22) Filed: May 6, 2010

Related U.S. Application Data
(60) Provisional application No. 61/179,449, filed on May 19, 2009.

(51) Int. Cl. G06F 3/048

(52) U.S. Cl. 715/808

(57) ABSTRACT

A method and system for notifying a user of an event or information using motion and transparency on a small screen display are provided. When an in-application event occurs or an indication that a new event has occurred, a notification window is created off display, and graphically animated on top of the current application display, in a small window which is un-obtrusive to user interaction in the active application. A user may set preferences for display location, size, transparency, color, time displayed, and content, and each window may vary based on the notification type, allowing users to quickly glance and identify the information displayed. The alert information may be summarized and or prioritized based on notification types,

### CROSS REFERENCE TO RELATED APPLICATIONS

This application claims the benefit of co-pending Provisional Patent Application No. 61/179,449 filed May 19, 2009, which is incorporated herein by reference.

### BACKGROUND OF THE INVENTION

1. Field of the Invention

The present invention generally relates to the field of mobile devices and other small screen displays, and more specifically, to the field of notifying a device user of new personal data or system event.

2. Description of the Prior Art

Mobile devices, such as cellular telephones, smart phones, personal digital assistants (“PDAs”), and other handheld devices, as well as other small display screens have very limited screen area to display information. Given the screen real estate limitations, notifying users of new information is typically displayed in a modal view, where user interaction is blocked until the user acknowledges the notification. As new PDA platforms have been developed, a new class of mobile applications, including mobile games, productivity applications, and utilities applications have come to market. When new information is available in these new application environments, mobile platform providers have faced a difficult decision of interrupting and frustrating the device user, or simply sending an audible alert without displaying what type of event or event summary the device user just received.

Furthermore, when an application is being displayed (“active application”) on a mobile device or other small screen displays, a running application may need to display status information on a process it is performing or status information (“in-application activity event”), but has limited area to display that information. This in-application activity information is difficult to display, as application developers must create a status bar, or other graphical components which prevent the user from viewing the entire display area. Dedicating space to in-application status area reduces the available display, and on mobile devices or other small screen displays, screen layout and application design is challenging with limited space available on the display screen.

Therefore a need exists to overcome the problems with the prior art as discussed above.

### SUMMARY OF THE INVENTION

According to a preferred embodiment of the present invention, a notification process provides a method and system to display notifications, summary notifications, in-application activity, and alerts to users without interrupting and with minimal interference to their current activity on a mobile device or small screen display. The notification is implemented using a semi-transparent window which graphically uses animated motion from an imaginary off-device position, thereby notifying the user that a new event has occurred which requires their attention, while still allowing the user to interact with the current active application. The event notification is displayed in a semi-transparent window, allowing the user to see through the window and choose to interact with the alert/notification, or continue to interact with the current active application. Based on user preferences, the alert can then either remain until a user interaction event has occurred, or a pre-determined amount of time has passed, the window is graphically animated off the display using animated motion while still maintaining the transparency over the current user application.

According to the method, multiple messages may be queued and either sequentially be displayed after a pre-determined amount of time or after specific user interaction, or messages may be prioritized and displayed before others despite the order in which they were received. Additionally, the number of awaiting notifications may be summarized in the notification window.

According to another aspect of the invention, one or more user interaction objects may be available to allow for specific tasks to be activated based on the type of notification received. For example, one embodiment of the invention is to show a mobile to mobile text message or SMS (“Short Message Service”) message has been received. This embodiment may contain user interaction objects allowing the user to reply, delete, or mark the message read.

According to another aspect of the invention, a transparent notification window may be graphically animated in from an off screen location on top of the current application window, by the current application, to alert the user to in-application activity. When that activity has been completed, the window may graphically animate off screen, indicating that task has been completed.

According to another aspect of the invention, a user may select the size, location, color, opacity/transparency, and time to display the notification window.

According to additional aspects of the method, the notification window may vary its color, shape, transparency, and location based on the type of event received and determined by user preference.

Both the foregoing general description and the following detailed description provide examples and explanations only. They do not restrict the claimed invention.

### BRIEF DESCRIPTION OF THE DRAWINGS

FIGS. 1A and 1B are screen diagrams detailing the components in one embodiment of the notification window.

FIG. 2A-2D are screen diagrams detailing the transparency and movement of the notification window.

FIG. 3 is a screen diagram detailing possible user interaction objects based on notification type.

FIG. 4 is a screen diagram detailing user preferences of the notification window based on notification type.

FIGS. 5A and 5B are screen diagrams detailing in-application transparent notification windows.

FIG. 6 illustrating an example of a process determining a notification system using motion and transparency in accordance with the present invention.

### DETAILED DESCRIPTION

The present invention, according to a preferred embodiment, overcomes problems with the prior art by providing a system to notify users of a new event, new available information, or status, without an intrusive interference with their current activity on a small screen display, including that of a handheld mobile device, such as a wireless transceiver (e.g., cellular phone or smart phone), pager, organizer, PDA, personal computer, or other similar computer devices with the typical components such as a memory, a process capable of running code, etc (“small screen display device” or “device”). This computer device is able to notify a user using visual notification of an event, status, or information, such as an incoming call, new email, new text message, calendar alert, system event, status, in-application event, or other events or information in which the user subscribes to or the application wishes to display to the user (“event”).

The present invention will now be described in more detail with reference to exemplary embodiments in which a notification window is incorporated into a handheld mobile device.

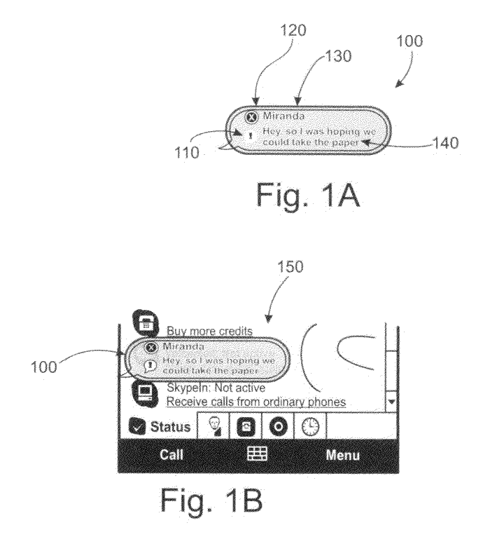

In FIG. 1A, an event occurs or is received on a small screen display device. If the device user wishes to receive information regarding the event or if an application on the device wishes to display information regarding the new event to the user, the system creates a semi-transparent alert window 100 to be displayed in a manner known in the art. The window 100 is created in an imaginary off-screen position with a pre-determined transparency level, and its geometry is typically much smaller then the entire screen display to reduce the amount of interference with the active application. The semi-transparent window 100 will allow the active application 150 to continue to be partially visible in areas which overlap the semi-transparent window. In one embodiment of the current invention, the window 100 displays a notification type 110 which may be selected to launch a predetermined application, an exit user interaction object 120 which will close the notification, and relevant information for that alert type. In one embodiment of said invention, a SMS text message is received on a smart phone. The window 100 contains 130 the sender name, and a brief summary of the notification data 140. Based on the notification type, the window 100 background is in the shape of a conversation bubble to allow the user to immediately identify the type of information being displayed.

In FIG. 1B, said notification window 100 is constructed and graphically animated into place over the existing application display 150 in a manner known in the art. The notification window 100 is transparent and does not interfere with the active application 150, allowing user interaction to continue and for overlapping areas of the window 100 and active application 150 to view both the window 100 and the active application 150.

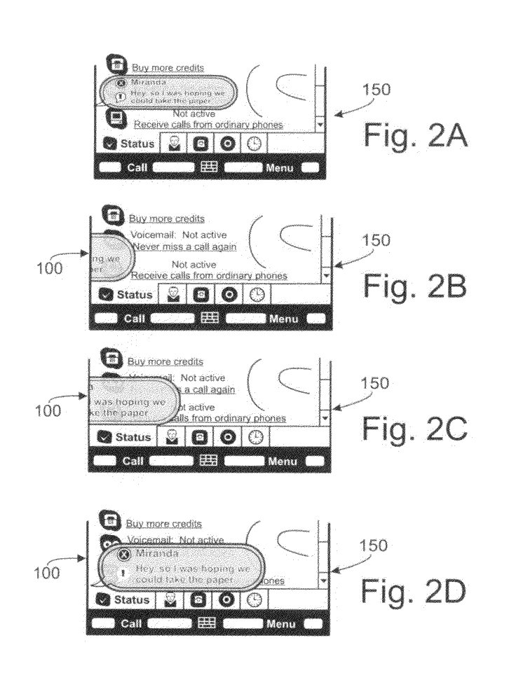

FIGS. 2A-2D illustrate the notification window 100 graphically animating in from an off screen position in a sliding manner, as to catch the attention of the user. The window remains semi-transparent, allowing the user to see through the notification window 100 and continue their task with the active application 150.

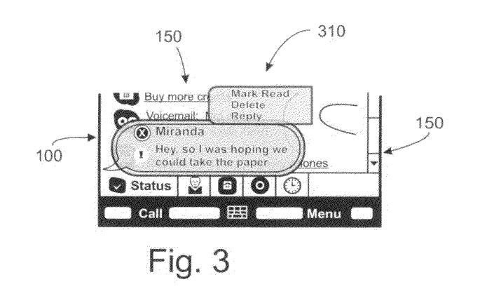

FIG. 3 illustrates interaction objects 310 with said notification window 100 based on the notification type. One embodiment of the invention shows options to mark as read, delete, and reply to the notification which can be activated by the user pressing on the notification window. When a user interacts with these options, the system takes the appropriate action, such as marking a message read.

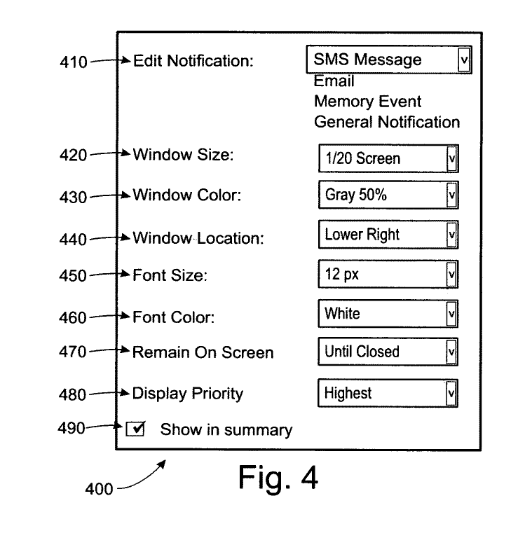

In FIG. 4, the notification window 100 can be changed based upon the type of event. An example embodiment 400 of the invention has a number of possible alert types 410 which may be applied to several events such as SMS, email, and similar. However, this list is simply to illustrate common types of alerts, and does not limit the invention to only these types of alerts. Notification window preferences 400 may be set for varying alert types, enabling window size 420, window color 430, window location 440, font size 450, font color 460, and the predetermined time to remain on screen 470. Specific alert types may take priority over others 480, while some alert types may be chosen to be summarized 490 in a summary notification window. While example choices are displayed in FIG. 4, these choices do not limit the invention to these values.

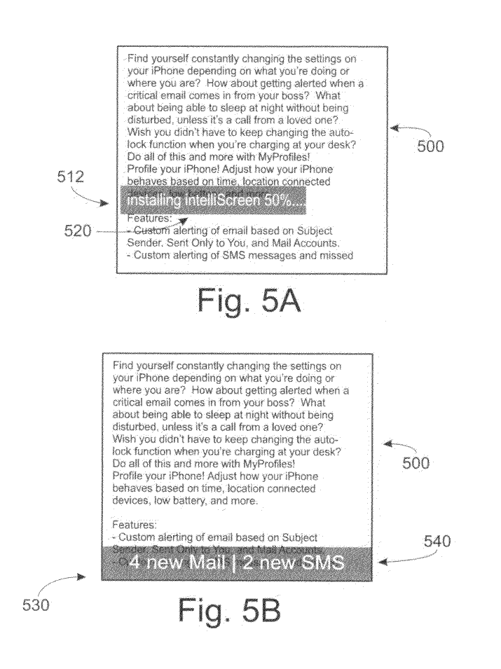

In FIG. 5A, within an active application 500, an in-application event is displayed to notify the user of current application activity. Similar to FIGS. 2A-2D, this notification window 510 was created off screen, and graphically animated into position to catch the user's eye. The notification window will remain until the activity 520 has been completed, and then graphically animated to a position off screen, indicating to the user the activity has completed. FIG. 5B displays another embodiment of the invention which shows summary information 540 of available notifications inside a transparent window 530 which has moved on top of the current active application using animated motion similar to FIGS. 2A-2D.

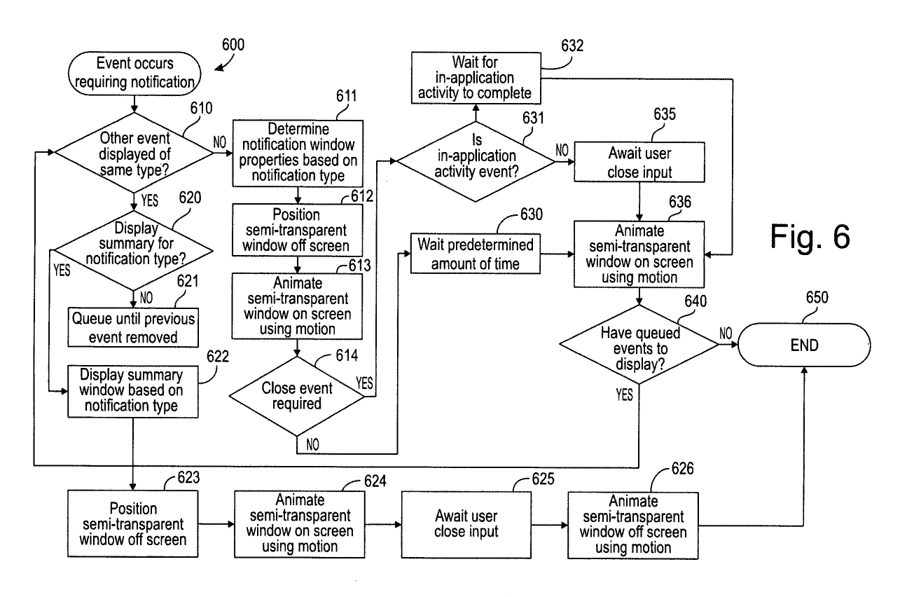

FIG. 6 is a flow diagram illustrating a process routine of a preferred embodiment of the current application to display a semi-transparent notification window using animated motion 600. At step 605, an event occurs which requires a notification to the user. Decision point 610 determines if another event of the same type or group is being displayed. If another event of the same type or group is being displayed, decision point 620 determines if a summary should be displayed for this notification type. If a summary should not be displayed, operation 621 queues the notification event for later display. If a summary should be displayed, operation 622 displays a summary window 530. Operation 623 positions the semi-transparent window 530 off screen and operation 624, animates the summary window 530 on screen using motion over the current application 500. Operation 625 awaits a user input to close the summary window 530. Operation 626 animates the semi-transparent summary window 530 using motion to an off screen position, where it ends.

At decision point 610, if another event of the same type or group is not being displayed, operation 611 uses the notification type or group to load properties for a semi-transparent window 100, based on the preferences the user specified using the configuration in FIG. 4. Operation 612 positions the semi-transparent window 100 off screen and operation 613 animates the semi-transparent window 100 on screen using motion over the current application 150.

At decision operation 614, if a close event is not required based on the notification type, operation 630 waits a predetermined amount of time before beginning operation 636 to animate the window 100 off screen using motion over the current application 150. Routine 600 continues on to decision operation 640.

If a close event is required at decision operation 614, decision point 631 determines if the event is an in-application activity event. If the event is an in-application activity event, operation 632 waits for the in-application activity to complete, and generates a close event continuing to operation 636. If the event is not an in-application activity event, operation 635 awaits user input 120 to generate a close event and continues to operation 636. At operation 636, window 100 is animated off screen using motion over the current application 150. Routine 600 continues on to decision operation 640.

At decision operation 640, if there are no events queued, routine 600 ends. If there are events queued, routine 600 returns to operation 610 described above.

While the inventions has been particularly shown and described with respect to a preferred embodiment thereof, it will be understood by those skilled in the art that the foregoing and other changes in form and details may be made therein without departing from the spirit and scope of the present application.

What is claimed is:

1. A method for notifying a user that an event has occurred or new information or status is available using a non-intrusive semi-transparent notification window, the method comprising:
receiving a new event or new information or status;
creating said notification window at an imaginary point off of the device display screen and subsequently graphically animating using motion said semi-transparent window on top of the current application, allowing the user to continue to interact with the active application;
wherein response to a close user interaction object, or after a predetermined amount of time, said notification window is graphically animated using motion off of the current display and active application to an imaginary point off of the display, while maintaining its preferred transparency on top of the active application.

2. The method of claim 1 further comprising the step of determining a notification window design and wherein the step of rendering the notification in accordance with the notification type comprises the step of rendering the notification in the notification window in accordance with the notification type.

3. The method of claim 2, wherein the type of user interaction objects available is determined based on a type of event, and displaying said objects where in said objects perform commons tasks based on the event type.

4. The method of claim 3, wherein a preferred location of said notification window is determined based on the type of event occurred;

5. The method of claim 4, wherein a preferred size of said notification window is determined based on the type of event occurred;

6. The method of claim 5, wherein a preferred transparency of said notification window is determined based on the type of event occurred;

7. The method of claim 6, wherein a preferred font size and color of text in said notification window is determined based on the type of event occurred;

8. The method of claim 2, wherein the event comprises the receipt of new information and wherein the notification window further comprises text including a portion of the new information received.

9. The method of claim 2, wherein the event comprises a notification of current background activity of the active application, wherein the notification window further comprises text indicating the current background activity;

10. The method of claim 2, wherein the event comprises summary information of available notifications and wherein the notification window further comprises text including a portion of the new information received.

11. A computer-readable medium having computer-executable instructions which cause the computer to perform the method of claim 1.

12. A computer-controlled apparatus capable of performing the method of claim 1.
